(19) United States
(12) Patent Application Publication
(10) Pub. No.: US 2004/0223998 A1
(43) Pub. Date: Nov. 11, 2004

(54) Insect repellent

(76) Inventors: Ganesh Natrajan Iyer, Mumbai (IN); Ramesh Trimbak Sane, Mumbai (IN); Sasikumar Menon, Mumbai (IN)

Correspondence Address: PHARMACEUTICAL PATENT ATTORNEYS, LLC, 55 MADISON AVENUE, 4TH FLOOR, MORRISTOWN, NJ, 07960-7397, US

(21) Appl. No.: 10/831,798

(22) Filed: Apr. 26, 2004

(30) Foreign Application Priority Data
Apr. 28, 2003 (IN) 422/MUM/2003

(51) Int. Cl. A01N 25/00; A01N 37/10; A01N 65/00; A01N 35/00; A01N 43/06

(52) U.S. Cl. 424/405; 424/725; 514/691; 514/438

(57) ABSTRACT

Mosquito-repellant and insecticidal compounds identified as oils present in the plant Blumea lacera [Burm. F.] DC. These compounds may be extracted from a plant source or synthetically synthesized and formulated to make anti-mosquito products.

### GOVERNMENT INTEREST

None.

### RELATED APPLICATIONS

This application claims priority from Novel Herbal Mosquito Repellant Compositions, India National Patent Application Serial No. ______/MUM/2003, dated 28 Apr. 2003 (copy enclosed), incorporated by reference. We also attach a copy of R. T. SANE and Sasikumar N. MENON, Development of New Herbal Mosquito Repellant: Mosquito Repellant Activity of Blumea lacera (Burm. F. DC) (2003) (unpublished); this is our paper describing our experimental work in detail; the paper forms part of this legal instrument and is intended to be read integrally with it.

### TECHNICAL FIELD

The present invention relates to novel herbal mosquito repellant compositions. More specifically the present invention elates to mosquito repellant compositions prepared from extracts of fresh leaves of Blumea lacera [Burm.f.] DC. Further these compositions are evaluated for knock and kill effect on mosquitoes as well as their toxicity. Further this invention relates to process for preparation of extract of Blumea lacera [Burm.f.] DC and their characterization by chromatographic techniques.

### BACKGROUND AND PRIOR ART

Mosquito menace is a global problem. Diseases like malaria, filariasis, Dengue fever, yellow fever, Japanese encephalitis, Ross river virus, Burma forest virus, Murrcey Valley encephalitis etc, are known to spread through mosquitoes. Even developed countries such as USA have seen a resurgence of mosquitoe menace and diseases like west Nile virus in the 21^{st} century. Developing and least developed countries from Africa, Asia, and Latin America and rest of the world have been unsuccessfully attempting to control the mosquito menace and to eradicate the scourge of malaria and other diseases.

However, elimination or eradication of mosquitoes or mosquitoes larvae, as well as development of safer, less toxic, more effective, human-friendly mosquito repellants have not received adequate attention of research communities.

There are very few natural or herbal solutions for repelling mosquitoes reported in the literature. Some natural products which effectively repel mosquitoes are reported, but they require more frequent reapplication (at least every 2 hours) and higher concentration than DEET. It is believed that products that contain multiple repellants tend to be more effective than those containing a single ingredient; however this is not proven by experiments. Natural repellants hitherto reported are based on volatile plant oils such as citronella oil, Castor oil, Rosemary oil, lemongrass oil, Cedar oil, peppermint oil, clove oil, geranium oil and possibly oils from verbena, pennyroyal, lavender, pine, cajuput, cinnamon, basil, thyme, allspice, soybean and garlic. Another plant-derived substance, pyrethrum is an insecticide which comes from the flowers of the daisy Chrysanthemum cinerariifolium.

Plant Derived Repellants:

Thousands of plants have been tested as potential sources of insect repellants. None of the plant derived chemicals tested to date, demonstrate the broad effectiveness and duration of DEET. Plants essential oils have been reported to have repellant activity, but when tested, most of these oils tend to give short-lasting protection, usually less than 2 hours.

Citronella is the active ingredient most commonly found in the natural or herbal insect repellants marketed in the US markets. It is registered with the EPA as an insect repellant. Studies show that citronella can be an effective repellant, but it provides shorter complete protection time than most DEET-based products. The citrosa plant (pelargonium citrosum ‘van leenii’) has been marketed as being able to repel mosquitoes through the continuous release of citronella oils. Unfortunately when tested, these plants offer no protection against bites.

A combination of soybean oil, geranium oil, and coconut oil in a formulation under the brand name of Bite Blocker has been released in the US market in 1997. Studies proved that this product gave more than 97% protection against under field conditions where as 6.65% DEET based spray afforded 86%, and citronella based repellant gave only 40% protection during the same period.

Permethrin is effective against mosquitoes, flies, ticks, and chiggers. Permethrin has low toxicity in mammals, and poorly absorbed by the skin. Permethrin should be applied directly to clothing or other fabrics. The spray form is nonstaining, nearly odor less, and resistant to degradation by heat or sun and maintains its potency for 2 weeks.

Anti-malarial drugs and drugs for other vector-borne diseases are known to have bad side-effects and develop resistance very fast. Most communities needing treatment and prevention are poor and unable to afford expensive health solutions for health care and sanitation. Even though the global magnitude of the problem is alarmingly increasing the attention to seek solutions to this scourge from research communities, from both developed and developing countries are minimal and extremely disappointing. Organizations like WHO, World Bank and NGO's world over are keen to encourage and support preventive and curative research efforts in this field.

We have recognized the urgency and magnitude of the need for inventing an effective, harmless, safe, non-toxic, and affordable mosquito repellant which can be formulated smoothly and effectively into a variety of compositions and delivery systems such as liquids, vapours and mats.

With this objective we have evaluated herbal plant for mosquito repellant properties. There are however very few prior art patents on mosquito repellants or herbal insect repellants. A few patents describe the chemical constituent of the mosquito repellant.

U.S. Pat. No. 6,291,745 reports limonene and other downstream metabolites of geranyl pyrophosphate for insect control in plants. U.S. Pat. No. 6,362,235 describes the method, apparatus and compositions for inhibiting the human scent tracking of mosquitoes in environmentally defined three dimensional spaces.

Neem is known to have been used in traditional Indian Communities as an insect and mosquito repellant.

Almost every household in urban India uses mosquito repellent in some form or the other. Various mosquito repellants currently marketed consist of DEET (N,N-diethyl-m-toluamide), Prallathrin, Allethrin, Cyclothrin, etc. as their active chemical ingredients. Most of the mosquito repellent formulations available in the market are mainly prepared with active ingredients of synthetic origin. Safety of these constituents is doubtful, and especially their long term effects. Development of a new safe mosquito repellant from herbal source is therefore the need of the hour. Mosquito menace is ubiquitous problem in Indian subcontinent. There are various methods which local populations use against mosquitoes with varying degrees of success rates.

Blumea lacera [Burm.f.] DC is a weed avoided by insects, and its insect repellant properties have already been reported. Its potential use in mosquito control however, has never been evaluated. Blumea lacera [Blurm.f.] DC (family Asteraceae) is a weed, growing in abundance in major parts of tropical and sub tropical parts of India. It has aromatic essential oil, which is reported to have an insect repellant property.

### SUMMARY OF THE INVENTION

Extracts of Blumea lacera are prepared by solvent extraction and also by steam distillation. These extracts and essential oils are standardized, evaluated and characterized using chromatographic techniques.

Further herbal mosquito repellent formulations in liquid, vapour and mat form are prepared from the said extracts. Polymer-bounded compositions for slow release are also prepared.

Knock and kill effect of Blumea lacera extracts and their formulations on mosquitoes is evaluated and compared with marketed branded formulations. Mosquito repellant activity of Blumea lacera compositions is established as equivalent or superior to market compositions.

Toxicity of the said extracts and compositions are evaluated to establish acceptable levels of active contents to optimize knock and kill effect (K&K) and knock down (KD) values.

### DETAILED DESCRIPTION

The present investigations were undertaken to standadardise the usefulness of the plant against mosquitoes and develop a formulation for mosquito repellent. The work is divided into two parts. The first part is to evaluate the phytoconstituents in the plant using Chromatography. The second part is to evaluate the Knock and Kill effect of the essential oils of Blumea lacera on mosquitoes.

Preparation of Extracts

Essential Oil Extraction by Steam Distillation:

The fresh leaves were separated from the plant and then introduced into the flask through which steam was passed. The water vapors along with the oil droplets were condensed. The condensed vapors and oil were collected in a collecting vessel. The entire distillate along with the oil was transferred to a separating funnel. To it diethyl ether was added and shaken to extract the oil from the aqueous medium. The ether layer was separated, passed through anhydrous sodium sulphate and then evaporated to dryness on a rotary vaporizer under vacuum at 40° C. Yellowish colour oil was obtained. This oil was used for chromatography.

A 10 μL/mL solution was prepared in diethyl ether and 20 μL of it was used for chromatographic separation.

Essential Oil Extraction Using Diethyl Ether Solvent:

Fresh leaves were separated from the plant and transferred to a 3 liter capacity beaker. To it diethyl ether solvent was added and the mouth of the beaker was sealed with aluminum foil and kept for extraction in a refrigerator for around 6 hours. At the end of the 6 hour period of extraction the leaves were squeezed with the aid of a manual screw tight squeezer made of brass to separate the solvent from the leaves. The solvent obtained was a mixture of ether and aqueous components. To separate the ether layer from the aqueous, the mixture was transferred to a separating funnel and allowed to stand undisturbed till the two layers were separated. The ether layer was separated, passed through anhydrous sodium sulphate and then evaporated to dryness on a rotary vaporizer under vacuum at 40° C. to yield a green coloured oily extract (0.08% to 0.09% of extract). This oily extract was used for chromatography. A 10 μL/mL solution was prepared in diethyl ether and 20 μL of it was used for chromatographic separation.

HPTLC Analysis of the Extracts:

The separation of essential oils was achieved by HPTL Chromatography, using toluene and ethyl acetate as mobile phase. Solution prepared for chromatographic separation were applied on HPTLC plate and developed with toluene and ethyl acetate (9:1) mobile phase. HPTLC plate was air dried, scanned and results obtained are tabulated in Table A. Further the same HPTLC plate was sprayed with 1% vanillin-sulfuric acid reagent, confirmatory test for presence of essential oil.

TABLE A
Data of Rf values for essential oil of Blumea lacera
obtained through steam distillation and solvent extraction.

| | |
|---|---|
| Sr. | AREA VALUE |

| No. | Rf | Steam Distillate | Diethyl ether Extract |
|---|---|---|---|
| 1 | 0.02 | 726.9 | 594.6 |
| 2 | 0.05 | | 67.8 |
| 3 | 0.06 | 21.9 | |
| 4 | 0.12 | | 284.1 |
| 5 | 0.15 | 24.8 | |
| 6 | 0.17 | 21.9 | 584.8 |
| 7 | 0.21 | 12.2 | |
| 8 | 0.25 | | 23.2 |
| 9 | 0.26 | 20.8 | |
| 10 | 0.32 | 974.0 | 152.5 |
| 11 | 0.39 | 184.4 | 27.3 |
| 12 | 0.44 | | 196.1 |
| 13 | 0.56* | 420.7 | |
| 14 | 0.58* | | 814.5 |
| 15 | 0.62* | 211.3 | |
| 16 | 0.64* | | 57.8 |
| 17 | 0.71 | 89.6 | |
| 18 | 0.84 | | 834.1 |
| 19 | 0.90 | 1644.0 | |
| 20 | 0.92 | | 432.8 |

Note:
The Rf values marked with * gave positive reaction for essential oil test using vanillin-sulfuric acid spray reagent.

HPLC Analysis of Blumea lacera Extracts

The oils (solution prepared for chromatographic separation) were free of ether and dissolved in acetonitrile to obtain a concentration of 1000 ppm concentration solution. A 100 ppm solution from 1000 ppm solution was made in mobile phase which was used for analysis. The separation of essential oils was achieved by using Jasco HPLC PU-1580 Pump, with acetonitrile and water as mobile phase. Table B provides details of the AUC and Rt for the peaks obtained in the chromatogram for both the extracts.

TABLE B
Data of Rt and AUC as obtained from HPLC analysis
for essential oil of Blumea lacera obtained through
steam distillation and diethyl ether extraction.

| | |
|---|---|
| Sr. | Area [uAU · Sec] |

| No. | Rt | Steam distillate | Diethyl ether extract |
|---|---|---|---|
| 1 | 1.60 | 15405 | |
| 2 | 1.67 | | 24104 |
| 3 | 2.03 | 122715 | |
| 4 | 2.28 | 456 | |
| 5 | 2.40 | | 4196 |
| 6 | 2.51 | 5956 | |
| 7 | 2.73 | | 5413 |
| 8 | 3.00 | 35214 | 3332 |
| 9 | 3.11 | | 948 |
| 10 | 3.37 | | 685 |
| 11 | 3.65 | | 16199 |
| 12 | 3.79 | 3878 | |
| 13 | 3.92 | 1202 | |
| 14 | 4.21 | 5506 | 20686 |
| 15 | 4.48 | 10525 | |
| 16 | 4.77 | | 12819 |
| 17 | 5.44 | 144712 | |
| 18 | 5.68 | | 105953 |
| 19 | 6.05 | 9146 | |
| 20 | 6.65 | 252761 | |
| 21 | 6.88 | | 25032 |
| 22 | 7.44 | | 4832 |
| 23 | 8.43 | 139166 | |
| 24 | 8.57 | | 44131 |
| 25 | 9.51 | 41399 | |
| 26 | 9.60 | | 427648 |
| 27 | 10.60 | 566993 | |
| 28 | 11.73 | 34697 | |
| 29 | 11.89 | | 12021 |
| 30 | 14.69 | 15930 | |

Head-Space GC/MS Analysis of Blumea lacera Extracts

Head-Space GC/MS analysis of Blumea lacera are conducted with fresh leaves, and with the essential oils obtained from the extracts of steam distillation and diethyl ether. The data obtained from MS analysis for the phytoconstituents have also been provided in Table C, D and E. The comparative account of the phytoconstituents identified using the two libraries (Wiley and Nist) from fresh leaves, diethyl ether solvent extract and steam distillate are summarized in table F.

Diethyl ether was selected as the solvent for extraction of essential oils as it not only gave more extraction yield but also more number of phytoconstituents by HPLC and HPTLC analysis as compared to the essential oil obtained through steam distillation. This is supported with the findings by Head Space/GC/MS analysis.

TABLE-C
Head-space GC/MS data of Fresh Leaves of Mature plant of Blumea lacera

| # | Name | Rt (min.) | Area | Area % | Hits | Library |
|---|---|---|---|---|---|---|
| 1 | Benzene, 1-methyl-2-(1-methylethyl)- | 8.867 | 4,658,767 | 2.83 | 978 | Nist |
| 2 | 3-Hexen-1-ol, acetate, (z)- | 9.840 | 2,086,173 | 1.27 | 993 | Wiley |
| 3 | 1-Hexanol (Amylcarbinol) | 10.521 | 2,703,811 | 1.64 | 986 | Wiley |
| 4 | 3-Hexen-1-ol, (z)-(leaf alcohol) | 11.170 | 9,369,711 | 5.70 | 993 | Wiley |
| 5 | Filifolone | 12.263 | 10,304,624 | 6.27 | 960 | Wiley |
| 6 | Chrysanthenone | 13.517 | 91,513,360 | 55.66 | 948 | Wiley |
| 7 | Isobornyl formate | 14.653 | 1,758,326 | 1.07 | 983 | Nist |
| 8 | Trans-caryophyllene | 14.966 | 16,127,021 | 9.81 | 992 | Wiley |
| 9 | Isoborneol | 16.091 | 9,127,859 | 5.55 | 983 | Wiley |
| 10 | Endoborneol | 16.599 | 1,493,022 | 0.91 | 995 | Wiley |
| 11 | Germacrene D | 16.707 | 14,424,373 | 8.77 | 977 | Wiley |
| 12 | Beta-sesquiphellandrene | 17.562 | 851,997 | 0.52 | 975 | Wiley |
| | | Total = | 164419044 | 100 | | |

TABLE-D
GC/MS Data of Diethyl ether extract of Mature Plant of Blumea lacera

| # | Name | Rt (min.) | Area | Area % | Hits | Library |
|---|---|---|---|---|---|---|
| 1 | Chrysanthenone | 13.554 | 22,396,530 | 13.44 | 968 | Wiley |
| 2 | Trans-caryophyllene | 15.049 | 14,107,937 | 8.47 | 990 | Wiley |
| 3 | 2-Cyclohexen-1-one,2-methyl-5-(1- | 16.457 | 7,688,311 | 4.61 | 966 | Wiley |
| | methylethyl)-, (s)- | | | | | |
| 4 | Germacrene D | 16.847 | 15,683,455 | 9.41 | 989 | Wiley |
| 5 | Geranyl tiglate | 21.874 | 8,096,687 | 4.86 | 970 | Wiley |
| 6 | Caryophyllene oxide | 25.210 | 12,026,824 | 7.22 | 892 | Nist |
| 7 | Bicyclo[2,2,1]heptan-2-one,4-ethynyl- | 25.676 | 42,109,920 | 25.27 | 651 | Nist |
| | 1,7,7-trimethyl- | | | | | |
| 8 | Bicyclo[2,2,1]heptan-2-one,4-ethynyl- | 26.391 | 22,521,348 | 13.52 | 651 | Nist |
| | 1,7,7-trimethyl- | | | | | |
| 10 | Thiophene,2,4-bis(1,1-dimethylethyl)- | 28.091 | 12,366,415 | 7.42 | 704 | Wiley |
| 11 | Palmitic acid | 32.436 | 9,622,583 | 5.78 | 954 | Wiley |
| | | Total = | 166,620,010 | 100 | | |

TABLE-E
GC/MS Data of Steam Distillate of Mature Plant of Blumea lacera

| # | Name | Rt (min.) | Area | Area % | Hits | Library |
|---|---|---|---|---|---|---|
| 1 | Filifolone | 12.371 | 5,827,105 | 5.03 | 966 | Wiley |
| 2 | 1-Octen-3-ol | 12.502 | 2,206,201 | 1.91 | 973 | Wiley |
| 3 | Chrysanthenone | 13.646 | 6,208,193 | 5.36 | 936 | Wiley |
| 4 | Bicyclo[2,2,1]heptan-2-one,1,7,7- | 13.810 | 395,003 | 0.34 | 957 | Wiley |
| | trimethyl- | | | | | |
| 5 | Alpha-terpinolene | 14.268 | 2,182,580 | 1.89 | 988 | Wiley |
| 6 | Carvomenthone | 14.410 | 616,681 | 0.53 | 978 | Wiley |
| 7 | Dimethyl sulphoxide | 14.966 | 435,478 | 0.38 | 970 | Nist |
| 8 | Carvotanacetone | 16.514 | 95,044,928 | 82.11 | 955 | Wiley |
| 9 | Endoborneol | 16.775 | 1,607,131 | 1.39 | 993 | Wiley |
| 10 | 9-Octadecen-1-ol (Oleol) | 18.236 | 447,928 | 0.39 | 828 | Wiley |
| 11 | Benzenemethanol | 19.316 | 776,954 | 0.67 | 975 | Wiley |
| | | Total = | 115748181 | 100 | | |

TABLE F
Summary of results of major components as identified by head-space GC/MS analysis of Blumea lacera

| Sr. No. | Constituent | Structure from library | Rt (min) | Fresh Leaves | Diethyl ether extract | Steam distillate |
|---|---|---|---|---|---|---|
| 1 | Chrysanthenone | 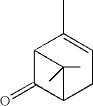 | 13.528 | 56.66% | 13.44% | 05.36% |
| 2 | Trans-caryophyllene | 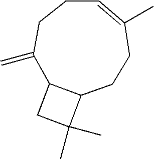 | 14.966 | 09.81% | 08.47% | 0.00% |
| 3 | Germacrene D | 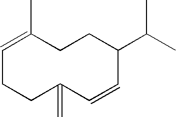 | 16.707 | 08.77% | 09.41% | 0.00% |
| 4 | Filifolone | No structure found in the library | 12.263 | 06.27% | 0.00% | 05.03% |
| 5 | Leaf alcohol | 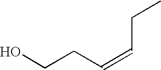 | 11.170 | 05.70% | 0.00% | 0.00% |
| 6 | Isoborneol | 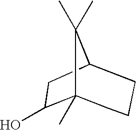 | 16.091 | 05.55% | 0.00% | 0.00% |
| 7 | Carvotanacetone | 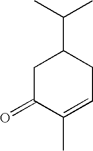 | 16.524 | 0.00% | 0.00% | 82.11% |

Evaluation of the Knock and Kill Effect of Blumea lacera.

The cage was made of wooden frames with glass fittings. The glass fittings were made in order to facilitate in the observation of the mosquito within the cage. The internal dimensions of the cage are as below;

| | |
|---|---|
| Length = | 78 cm |
| Breath = | 68 cm |
| Height = | 68 cm |
| Volume of the cage = | 360672 cm³ |

The floor of the cage was marked into 8 quadrants. A plug point is provided inside the cage for fitting the vaporizing machine with external power on/off switch. This enables one to control the time for which the machine can be switched on and off during the experiment without disturbing the mosquitoes inside the cage. This plug point is refereed to as the source. The cage sides are adequately sealed with a sealant to plug leakage of vapours.

The experiments were divided into two sections;

Section 1: To establish the mosquito repellant activity of the herb and compare it with some marketed formulations (positive control).

Section 2: To establish the KD₅₀ and KD₉₀ of the extract of Blumea lacera and compare it with some marketed formulations (positive control).

The experiments in Section 1 are illustrated by the following Examples,

General procedure:

The test material is placed in the first quadrant (source). Known numbers of mosquitoes (mixed population) are introduced into the “Knock and Kill” cage. The mosquitoes are given a period of 10 minutes for acclimatization. After 10 minutes 0.00 hour reading is taken and the mosquito count with respect to their position in the quadrants recorded. Subsequent readings are made as explained in the respective experiments. Observations are made on the behaviour of the mosquitoes and for the knock and kill effect (if any) due to the test materials/conditions.

### EXAMPLE 1

The experiments in this stage were designed to evaluate the effect of the closed cage environment without any test substance on the mosquitoes.

To study the behaviour pattern of the mosquitoes in the Knock and Kill cage under normal conditions i.e. without any treatment or test substance, the mosquitoes were introduced in to the cage. Initially mosquitoes were flying randomly throughout the cage. After 10 minutes of acclimatizing to the new environment some of the mosquitoes had settled down and their count recorded. The settling and flying pattern of the mosquitoes was recorded for a period of 6.00 hours. Around 15% were still flying or active, 65% had settled down and 20% knocked down after 3.00 hours. Around 1% still active, 35% settled down, 42% knocked down and 22% death at the end of 4.00 hours was observed

### EXAMPLE 2

The experiments in this stage were designed to evaluate the effect of deodorised kerosene, which is the solvent in the marketed formulations.

To study the behaviour pattern of the mosquitoes in the “Knock and Kill” cage due to the vapours of deodorised kerosene, filled in a vial which was attached to a vaporizer introduced into the cage. When the mosquitoes were introduced in to the cage they were flying randomly throughout the cage. After 10 minutes of acclimatizing to the new environment some of the mosquitoes had settled down and their count recorded. The flying, settling, knocked down and death pattern of the mosquitoes was recorded for a period of 4.00 hours. Around 11% were still flying or active, 48% had settled down and 41% knocked down was observed at the end of half an hour of experimentation About 7% were still sitting, 53% knock down and 40% mortality at the end of 1.00 hour of experimentation. Cent percent mortality was observed it the end of 2.00 hours of experiment. Appendage shedding was also observed at the end of 0.50 hours of experimentation.

### EXAMPLE 3

The experiments in this stage were designed to evaluate the effect of the Positive control samples obtained from the local market in liquid and mat form (Marketed commercial products).

To study the behaviour pattern of the mosquitoes in the “Knock and Kill” cage with branded formulations in the market which will serve as positive control was done. Three products were taken from the market at random. Two were in the form of mat and one as a liquid. All the three products contained the same active ingredient. The mats or the liquid were placed in position with the vaporizing machine inside the cage. The flying, settling, knocked down and death pattern of the mosquitoes was recorded for a period of 4.00 hours. Knocked down of mosquitoes was seen at the end of 0.50 hours of their contact with the vapors of the test material. The knocked down rate was almost 100% for all the three formulations containing prallathrin at concentrations ranging from 1.0% to 1.6%. Mat containing 1.0% prallathrin showed around 20% death, while mat containing 1.2% prallathrin showed around 40% death and liquid containing 1.6% prallathrin showed around 95% death at the end of 2.00 hrs. Cent percent mortality was observed for liquid sample at the end of 3.00 hrs and for 1.2% prallathrin mat it was observed after 4.00 hours. One percent prallathrin mat on the other hand showed around 70% mortality at the end of 4.00 hours. It was observed that knocked down mosquitoes showed circular movements in the upside down position. All the dead mosquitoes had their wings folded inwards. Appendage shedding was also observed at the end of 2.00 hours of experimentation.

### EXAMPLE 4

The experiments in this stage were designed to evaluate the effect of intact fresh leaves of Blumea lacera.

To study the behaviour pattern of the mosquitoes in the “Knock and Kill” cage due to the introduction of known amount of fresh leaves of Blumea lacera, weighed amount (25 g) of fresh leaves were taken in a wide mouth shallow plastic container (6 inches diameter and 3 inches height). The mouth of the container was covered with a piece of mosquito net. The container with the leaves was placed inside the cage in the first quadrant. Observations were made for 4 hours. At the end of the first hour of the mosquitoes interaction with the vapors of volatile components of the fresh leaves of Blumea lacera, 13% of the mosquitoes were still flying. Around 10% active or flying, 69% settled down and 20% knock down was observed at the end of 2.00 hours and around 27% settled down and 73% knock down at the end of 4.00 hours. At the end of first hour after the count the mosquitoes were disturbed by taping at the walls of the cage to observe if the mosquitoes that had settled down were in a position to fly or not. It was interesting to observe that the mosquitoes could not be dislodged from their position.

### EXAMPLE 5

The experiments in this stage were designed to evaluate the effect of essential oils from fresh leaves obtained through steam distillation in liquid form.

To study the behaviour pattern of the mosquitoes in the Knock and Kill cage after introduction of essential oils obtained from the fresh leaves of Blumea lacera by steam distillation in liquid form was prepared in deodorized kerosene and was used for testing the mosquito repellent activity. A 10,000 ppm (12.5% w/w) solution of the yellowish coloured oil obtained through steam distillation was prepared in deodorized kerosene and was used for testing the mosquito repellent activity. The liquid was transferred to a bottle and attached to a vaporizing machine that was placed in position inside the cage. Observations were made for 4 hours. Steam distillate extract of Blumea lacera showed 45% knock down at the end of half an hour of the mosquitoes interaction with the vapors. Around 54% mortality was observed at the end of 1.00 hour and 100% mortality at the end of 2.00 hours of experimentation. It was observed that knocked down mosquitoes showed circular movements in the upside down position. Almost all the dead mosquitoes had their wings folded inwards and some had their wings stretched out horizontally. Shedding of appendages was also observed from 0.50 hour of experimentation.

### EXAMPLE 6

The experiments in this stage were designed to evaluate the effect of essential oils from fresh leaves obtained through diethyl ether solvent extraction in liquid form.

To study the behaviour pattern of the mosquitoes in the Knock and Kill cage, a 10,000 ppm (12.5% w/w) solution of the greenish coloured oil obtained through diethyl ether solvent extraction was prepared in deodorized kerosene and was used for testing the mosquito repellent activity. The liquid was transferred to a bottle and attached to a vaporizing machine, which was placed in position inside the cage. Observations were made for 4 hours. Diethyl ether extract of Blumea lacera showed 85% knock down at the end of half an hour of the mosquitoes interaction with the vapors. Around 63% mortality was observed at the end of 1.00 hour and 100% mortality at the end of 2.00 hours. It was observed that knocked down mosquitoes showed circular movements in the upside down position. Almost all the dead mosquitoes had their wings folded inwards and some had their wings stretched out horizontally. Shedding of appendages was also observed from 0.50 hour of experimentation.

### EXAMPLE 7

The experiments in this stage were designed to evaluate the effect of essential oils from fresh leaves obtained through diethyl ether solvent extraction in mat form. 7

To study of the behaviour pattern of the mosquitoes in the Knock and Kill cage, essential oils obtained from the fresh leaves of Blumea by steam distillation and diethyl ether extract was introduced in the cage. Mats were prepared inhouse using 4 rectangular pieces of Whatman filter paper of the dimensions 4 cm×2 cm. The 4 pieces of filter paper were secured together by applying staple pins. Then known amount of the extract was applied on the mat and the mat was introduced into the cage with the vaporizer. Observations were made for 4 hours for four different concentrations such as 1000 μL of extract corresponds to 400 mg, 500 μL of extract corresponds to 200 mg, 250 μL of extract corresponds to 100 mg, 100 μL of extract corresponds to 40 mg.

### Example 7.1

### Knock Down Effect for 400 mg of Diethyl Ether Extract

Diethyl ether extract of Blumea showed 97% knock down at the end of half an hour of the mosquitoes interaction with the vapors. Around 24% mortality was observed at the end of 2.00 hours and 100% mortality at the end of 4.00 hours. Appendage shedding was observed in all knocked down mosquitoes. Knocked down mosquitoes showed circular movements in the upside down position. Some of the dead mosquitoes had their wings folded inwards while others had it stretched out horizontally.

### Example 7.2

### Knock Down Effect for 200 mg of Diethyl Ether Extract

Diethyl ether extract of Blumea showed 55% knock down at the end of half an hour of the mosquitoes interaction with the vapors. Around 22% mortality was observed at the end of 3.00 hours and 39% mortality at the end of 4.00 hours. Appendage shedding was observed only in some knocked down mosquitoes. Some of the knocked down mosquitoes showed circular movements in the upside down position. Almost all of the dead mosquitoes had their wings stretched out horizontally.

### Example 7.3

### Knock Down Effect for 100 mg of Diethyl Ether Extract

Diethyl ether extract of Blumea showed 48% knock down at the end of half an hour and 91% knock down at the end of 2.00 hours of the mosquitoes interaction with the vapors. Around 4% mortality was observed at the end of 3.00 hours and 26% mortality at the end of 4.00 hours. Appendage shedding was not observed. Circular movements in the upside down position not observed. All the dead mosquitoes had their wings stretched out horizontally.

### Example 7.4

### Knock Down Effect for 40 mg of Diethyl Ether Extract

Diethyl ether extract of Blumea lacera showed 14% knock down at the end of half an hour and 68% knock down at the end of 4.00 hours of the mosquitoes interaction with the vapors. No mortality was observed in the mosquitoes by the end of 4.00 hours of interaction with the vapours. Appendage shedding was not observed. Circular movements in the upside down position not observed. All the dead mosquitoes had their wings stretched out horizontally.

### EXAMPLE 8

The experiments in this section were designed to evaluate the effect of essential oils from fresh leaves of Blumea lacera obtained through diethyl ether solvent extraction when bound with polymer binder intended for slow release.

To evaluate the Knock Down effect of essential oils from fresh leaves of Blumea lacera obtained through diethyl ether solvent extraction when bound with polymer binders intended for slow release.

Mixture 1 was prepared with 400 mg of the extract by mixing with 1.0 g of binder and

Mixture 2 was prepared with 200 mg of the extract by mixing with 1.0 g of binder. These two mixtures were used for the experiment with the above said procedure.

Record of knock down was made for each minute up to 240 minutes. Experiments with mosquitoes were carried out to evaluate the KD value under different experimental conditions.

Condition 1: Vaporization of the essential oils in the experimental cage containing mosquitoes—at room temperature (without heating).

Observation: The KD value was found to be 30% by the end of 1.0 hour and 60% by the end of 4.0 hours of experimentation with mixture 1.

Condition 2: Vaporization of the essential oils in the experimental cage containing mosquitoes—by heating using vaporizer.

Observation: The KD value was found to be 91% and 100% by the end of 1.50 hours of experimentation for mixture 2 and mixture 1 respectively. The KD value was 100% by the end of 3.0 hours of experimentation with mixture 2.

Condition 3: Vaporization of the essential oils in the experimental cage containing mosquitoes—at room temperature for 24 hours in open environment and then in KD cage by heating using vaporizer.

Observation: The KD value was found to be 24% and 47% by the end of 2.00 hours of experimentation with mixture 2 and mixture 1 respectively. The KD value was 38% and 67% by the end of 4.00 hours of experimentation with mixture 2 and mixture 1 respectively.

Condition 4: Vaporization of the essential oils in the experimental cage containing mosquitoes—with heating using vaporizer then gap for two hours and reheating the same mixture.

Observation: The KD value was found to be 100% by the end of 2.00 hours of experimentation with mixture 1 for the first 4 hours. The KD value was 53% by the end of 4.0 hours of experimentation with the same mixture 1 used in the first cycle.

Comparative effect of positive control and extracts of Blumea lacera fresh leaves in liquid form.

Positive control in liquid form containing 1.6% w/w Prallathrin in Deodorised kerosene [D.O.K.].

Essential oils obtained through steam distillation of Blumea lacera leaves in liquid form containing 12.5% w/w in D.O.K. liquid

Essential oils obtained through diethyl ether solvent extraction Blumea lacera leaves in liquid form containing 12.5% w/w in D.O.K. liquid

| Effect of | 0.50 hr | 1.00 hr | 2.00 hr | 3.00 hr |
|---|---|---|---|---|
| No treatment control | All Active | 80% resting | 85% resting | 65% resting |
| | | | | 20% KD |
| Deodorised kerosene | 47% resting | 54% KD | 100% Dead | — |
| | 41% KD | 39% Dead | | |
| 1.6% w/w prallathrin in | 8% resting | 100% KD | 5.4% KD | 100% Dead |
| D.O.K. | 90% KD | | 95% Dead | |
| 12.5% w/w essential oils of | 45% resting | 46% KD | 100% Dead | — |
| Blumea obtained through | 45% KD | 54% Dead | | |
| steam distillate in D.O.K. | | | | |
| 12.5% w/w essential oils of | 14% resting | 36% KD | 100% Dead | — |
| Blumea obtained through | 84% KD | 62% Dead | | |
| diethyl ether solvent | | | | |
| extraction in D.O.K. | | | | |

Note:
KD—knocked down

General Observations for All Samples in Liquid Form:

Appendage shedding by the knocked down mosquitoes was observed from 0.50 hr. Knocked down mosquitoes showed circular movements in the upside down position. All the dead mosquitoes had their wings folded inwards.

Comparative effect of positive control and extracts of Blumea lacera fresh leaves in mat form.

Positive control in mat form containing 1.0% and 1.2% w/w Prallathrin in deodorised kerosene [D.O.K.].

Essential oils obtained through diethyl ether solvent extraction Blumea lacera leaves in mat form containing the extract as whole ranging from concentration of 400 mg to 40 mg.

| Effect of | 0.50 hr | 1.00 hr | 2.00 hr | 3.00 hr | 4.00 hr |
|---|---|---|---|---|---|
| Normal Control | All Active | 80% | 85% | 65% | 42% KD |
| | | resting | resting | resting | |
| | | | | 20% KD | 22% dead |
| 1.0% w/w | 100% KD | 100% KD | 82% KD | 57% KD | 28% KD |
| Prallathrin | | | 18% Dead | 43% Dead | 72% Dead |
| 1.2% w/w | 3% resting | 100% KD | 60% KD | 23% KD | 100% Dead |
| Prallathrin | 97% KD | | 40% Dead | 77% Dead | |
| 400 mg diethyl ether | 2% resting | 100% KD | 76% KD | 54% KD | 100% Dead |
| extract (Blumea) | 97% KD | | 24% Dead | 46% Dead | |
| 200 mg diethyl ether | 34% | 100% KD | 91% KD | 78% KD | 61% KD |
| extract (Blumea) | resting | | | | |
| | 55% KD | | 9% Dead | 22% Dead | 39% Dead |
| 100 mg diethyl ether | 41% | 17% | 9% resting | 89% KD | 69% KD |
| extract (Blumea) | resting | resting | | | |
| | 48% KD | 80% KD | 91% KD | 4% Dead | 26% Dead |
| 40 mg diethyl ether | 64% | 57% | 40% | 34% | 29% |
| extract (Blumea) | resting | resting | resting | resting | resting |
| | 14% KD | 31% KD | 54% KD | 63% KD | 68% KD |

The experiments in Section 2 are illustrated by the following Examples:

### EXAMPLE A

The experiments in this stage were designed to evaluate the KD₅₀ and KD₉₀ of the closed cage environment without any test substance.

To evaluate the KD₅₀ and KD₉₀ of the closed cage environment without any test substance with the above said procedure, the record of knock down was made for each minute up to 240 minutes.

Observation: The KD₅₀ value was found to be 281.60 minutes (4.69 hr) and KD₉₀ was found to be 1479.00 minutes (24.65 hr).

### EXAMPLE B

The experiments in this stage were designed to evaluate the KD₅₀ and KD₉₀ of deodorised kerosene, which is the solvent used in the marketed formulations.

To evaluate the KD₅₀ and KD₉₀ of deodorised kerosene, which is the solvent, used in the marketed formulations with the above said procedure, the record of knock down was made for each minute up to 240 minutes.

Observation: The KD₅₀ value was found to 34.34 minutes (0.57 hr) and KD₉₀ was found to be 115.70 minutes (1.93 hr).

### EXAMPLE C

The experiments in this stage were designed to evaluate the KD₅₀ and KD₉₀ of the positive control samples obtained from the local market in liquid and mat form.

To evaluate the KD₅₀ and KD₉₀ of positive control samples obtained from the local market in liquid and mat form, with the same procedure, the record of knock down was made for each minute up to 240 minutes.

Observation: The KD₅₀ value was found to 12.42 minutes (0.21 hr) and KD₉₀ was found to be 80.95 minutes (1.35 hr) for marketed mosquito repellent in mat form containing 1.0% w/w prallathrin.

The KD₅₀ value was found to 10.10 minutes (0.17 hr) and KD₉₀ was found to be 78.39 minutes (1.31 hr) for marketed mosquito repellent in mat form containing 1.2% w/w prallathrin.

The KD₅₀ value was found to 27.97 minutes (0.47 hr) and KD₉₀ was found to be 104.20 minutes (1.74 hr) for marketed mosquito repellent in mat form containing 4.0% w/w allethrin.

The KD₅₀ value was found to 21.56 minutes (0.36 hr) and KD₉₀ was found to be 101.60 minutes (1.69 hr) for marketed mosquito repellent in liquid form containing 1.6% w/w prallathrin.

### EXAMPLE D

The experiments in this stage were designed to evaluate the KD₅₀ and KD₉₀ of herbal mosquito repellent formulation of Blumea lacera in liquid form.

To evaluate the KD₅₀ and KD₉₀ of herbal mosquito repellent formulation of Blumea lacera in liquid form with the above mentioned procedure, a 1.0% w/w solution of essential oils of Blumea lacera obtained through diethyl ether solvent extract was prepared in deodorised kerosene and the record of knock down was made for each minute up to 240 minutes.

Observation: The KD₅₀ value was found to 23.34 minutes (0.39 hr) and KD₉₀ was found to be 109.10 minutes (1.82 hr) for herbal mosquito repellent formulation of Blumea lacera in liquid form.

### EXAMPLE E

The experiments in this stage were designed to evaluate the KD₅₀ and KD₉₀ of essential oils from fresh leaves of Blumea lacera obtained through diethyl ether solvent extraction in mat form at varying concentrations.

To evaluate the KD₅₀ and KD₉₀ of essential oils from fresh leaves of Blumea lacera obtained through diethyl ether solvent extraction in mat form at varying concentrations with the above said procedure and the record of knock down was made for each minute up to 240 minutes.

Observation: The KD₅₀ value was found to 11.22 minutes (0.19 hr) and KD₉₀ was found to be 78.14 minutes (1.30 hr) for 400 mg of essential oils obtained through diethyl ether solvent extraction.

The KD₅₀ value was found to 21.38 minutes (0.36 hr) and KD₉₀ was found to be 96.99 minutes (1.62 hr) for 200 mg of essential oils obtained through diethyl ether solvent extraction.

The KD₅₀ value was found to 35.88 minutes (0.60 hr) and KD₉₀ was found to be 136.10 minutes (2.27 hr) for 100 mg of essential oils obtained through diethyl ether solvent extraction.

The KD₅₀ value was found to 85.70 minutes (1.43 hr) and KD₉₀ was found to be 410.20 minutes (6.84 hr) for 40 mg of essential oils obtained through diethyl ether solvent extraction.

The KD₅₀ value was found to 116.90 minutes (1.95 hr) and KD₉₀ was found to be 497.30 minutes (8.29 hr) for 20 mg of essential oils obtained through diethyl ether solvent extraction.

Data for Mosquito Population of Female Only

The KD₅₀ value was found to 15.14 minutes (0.25 hr) and KD₉₀ was found to be 46.77 minutes (0.78 hr) for 200 mg of essential oils obtained through diethyl ether solvent extraction.

The KD₅₀ value was found to 17.38 minutes (0.29 hr) and KD₉₀ was found to be 69.18 minutes (1.15 hr) for 100 mg of essential oils obtained through diethyl ether solvent extraction.

The KD₅₀ value was found to 93.33 minutes (1.56 hr) and KD₉₀ was found to be 524.81 minutes (8.75 hr) for 40 mg of essential oils obtained through diethyl ether solvent extraction.

The KD₅₀ value was found to 120.23 minutes (2.00 hr) and KD₉₀ was found to be 660.69 minutes (11.01 hr) for 20 mg of essential oils obtained through diethyl ether solvent extraction.

### EXAMPLE F

The experiments in this stage were designed to evaluate the KD₅₀ and KD₉₀ of herbal mosquito repellent formulation of Blumea lacera in mat form.

To evaluate the KD₅₀ and KD₉₀ of herbal mosquito repellent formulation of Blumea lacera in mat form with the above said procedure, a 1.0% w/w solution of essential oils of Blumea lacera obtained through diethyl ether solvent extract was prepared as detailed below.

10% w/w of essential oils of Blumea lacera

34% w/w of deodorised kerosene

32% w/w of isopropyl myristate

24% w/w of piperonyl butoxide

One ml of the above formulation was taken on an in-house prepared mat. The mat was made of 13 rectangular pieces of Whatman filter paper stapled together. The weight of the formulation taken on the mat was approximately 850 mg. The procedure was the same as described under 3.2.1 and 3.2.4.2. Record of knock down was made for each minute up to 240 minutes. The experimentation was done on mosquito population of females only.

Observation: The KD₅₀ value was found to 35.77 minutes (0.60 hr) and KD₉₀ was found to be 134.80 minutes (2.25 hr) for herbal mosquito repellent formulation of Blumea lacera in mat form.

Acute Inhalation Toxicity with the Test Item in Wistar Rats:

Exhaustive acute inhalation toxicity was determined in Wistar rats of both sex by exposure to aerosol of 50% w/v concentration of the test item in Dimethyl sulfoxide and 50% w/v concentration of the test item in deodorised kerosene generated by a glass atomizer at an injection rate of 0.4 ml/min. The average gravimetric concentration of 1.98±0.06 mg of the test item per litre of chamber air (maximum attainable concentration) was achieved. The rats housed in special rat restrainers were continuously exposed to the aerosol (head and nose exposure) for four hours in a 0.5 m³ glass/stainless steel exposure dynamic state inhalation chamber. The aerosol sampled from the inhalation chamber for particle size analysis showed a mean aerosol particle size of 1.03±0.48 micrometers. The animals were observed for 7 days after the day of exposure and were then necropsied and subjected to gross pathological examination. There were no toxic signs, pre-terminal deaths and no abnormalities were detected at necropsy.

While the present invention is described above in connection with preferred or illustrative examples and these examples are not intended to be exhaustive or limiting of the invention. Rather, the invention is intended to cover all alternatives, modifications and equivalents included within its scope, as defined by the appended claims.

For example, we here teach formulations suitable for vaporization to clear mosquitoes from a room or a home. One way to do this is to load the active compound (perfume, insecticide, et cetera) as a liquid on a fibrous or porous “mat,” such as a piece of filter paper, which increases the surface area of the active ingredient exposed to air, and thus increases the amount of active ingredient which vaporizes per unit of time. Gently heating the mat will of course heat the active ingredient, thus increasing its rate of vaporization. By controlling the mat size, the mat temperature, and the formulation's vaporization constant, one can adjust the rate at which an enclosed space such as a bedroom will fill with vaporized active ingredient.

One of skill in the art could readily modify this to make a formulation for application directly on the user's skin (as a cream or lotion, for example) or clothes (as an aerosol spray, for example). This enables a user to use our invention while outdoors. This formulation would of necessity be heated by the user's body heat, and thus vaporize to a certain extent, providing a small “cloud” of vaporized active around the user; the vaporization rate can be adjusted by, for example, mixing the active ingredient with a vaporization-inhibiting polymer or oil.

In the appended claims, we use the term “anti-mosquito” to encompass repelling mosquitoes, and/or inhibiting their mobility or their biting behavior, and/or killing mosquitoes.

We claim:

1. A method to repel or kill mosquitoes, the method comprising: providing and an anti-mosquito compound present in Blumea lacera; said compound provided in an anti-mosquito effective amount.

2. The method of claim 1, said anti-mosquito compound comprising an organic phase extract of Blumea lacera.

3. The method of claim 2, further comprising deodorized kerosene, isopropyl myristate, and poperonyl butoxide.

4. The method of claim 2, said anti-mosquito compound mixed with a polymer in an amount effective to change the rate at which said anti-mosquito compound vaporizes.

5. The method of claim 4, said anti-mosquito compound provided in a formulation suitable for use on a vaporizing mat.

6. The method of claim 1, said anti-mosquito compound selected from the group consisting of: benzenemethanol; benzene, 1-methyl-2-(1-methylethyl)-; bicycle[2,2,1]heptan-2-one, 1,7,7-trimethyl-; bicyclo[2,2,1]heptan-2-one,4-ethynyl-1,7,7-trimethyl-; carvomenthone; carvotanacetone; caryophyllene oxide; trans-caryophyllene; chrysanthenone; 2-Cyclohexen-1-one, 2-methyl-5-(1-methylethyl)-, (s)-; dimethyl sulphoxide; endoborneol; filifolone; geranyl tiglate; Germacrene D; 1-hexanol; 3-hexen-1-ol, (z)-; 3-hexen-1-ol, acetate, (z)-; isoborneol; Isobornyl formate; 1-octen-3-ol; 9-octadecen-1-ol; palmitic acid; α-sesquiphellandrene; α-terpinolene; and thiophene,2,4-bis(1,1-dimethylethyl)-.

7. The method of claim 6, said anti-mosquito compound selected from the group consisting of: trans-caryophyllene; chrysanthenone; and Germacrene D.

8. The method of claim 7, said anti-mosquito compound comprising trans-caryophyllene.

9. The method of claim 7, said anti-mosquito compound comprising chrysanthenone.

10. The method of claim 7, said anti-mosquito compound comprising Germacrene D.

11. The method of claim 7, said anti-mosquito compound mixed with a polymer in an amount effective to change the rate at which said anti-mosquito compound vaporizes.

12. A composition of matter comprising an anti-mosquito compound present in Blumea lacera, said compound provided in an anti-mosquito effective amount.

13. The composition of matter of claim 12, said anti-mosquito compound comprising an organic phase extract of Blumea lacera.

14. The composition of matter of claim 13, further comprising deodorized kerosene, isopropyl myristate, and poperonyl butoxide.

15. The composition of matter of claim 13, said anti-mosquito compound mixed with a polymer in an amount effective to change the rate at which said anti-mosquito compound vaporizes.

16. The composition of matter of claim 15, said anti-mosquito compound provided in a formulation suitable for use on a vaporizing mat.

17. The composition of matter of claim 12, said anti-mosquito compound selected from the group consisting of: benzenemethanol; benzene, 1-methyl-2-(1-methylethyl)-; bicycle[2,2,1]heptan-2-one,1,7,7-trimethyl-; bicyclo[2,2,1]heptan-2-one,4-ethynyl-1,7,7-trimethyl-; carvomenthone; carvotanacetone; caryophyllene oxide; trans-caryophyllene; chrysanthenone; 2-Cyclohexen-1-one, 2-methyl-5-(1-methylethyl)-, (s)-; dimethyl sulphoxide; endobomeol; filifolone; geranyl tiglate; Germacrene D; 1-hexanol; 3-hexen-1-ol, (z)-; 3-hexen-1-ol, acetate, (z)-; isoborneol; Isobornyl formate; 1-octen-3-ol; 9-octadecen-1-ol; palmitic acid; β-sesquiphellandrene; α-terpinolene; and thiophene,2,4-bis(1,1-dimethylethyl)-.

18. The composition of matter of claim 17, said anti-mosquito compound selected from the group consisting of: trans-caryophyllene; chrysanthenone; and Germacrene D.

19. The composition of matter of claim 18, said anti-mosquito compound comprising trans-caryophyllene.

20. The composition of matter of claim 18, said anti-mosquito compound comprising chrysanthenone.

21. The composition of matter of claim 18, said anti-mosquito compound comprising Germacrene D.

22. The composition of matter of claim 18, said anti-mosquito compound mixed with a polymer in an amount effective to change the rate at which said anti-mosquito compound vaporizes.
